(19) United States
(12) Patent Application Publication
(10) Pub. No.: US 2010/0143017 A1
(43) Pub. Date: Jun. 10, 2010

(54) SYSTEM AND METHOD FOR GENERATING BUSINESS DOCUMENTS

(75) Inventors: John W. Christenson, Bloomington, MN (US); Henry P. Schultz, Oakdale, MN (US); Dennis J. Shilling, Lakewood, NY (US)

Correspondence Address: K&L GATES LLP, 210 SIXTH AVENUE, PITTSBURGH, PA, 15222-2613, US

(73) Assignee: Ennis, Inc., Midlothian, TX (US)

(21) Appl. No.: 12/330,762

(22) Filed: Dec. 9, 2008

(51) Int. Cl. B41J 11/00

(52) U.S. Cl. 400/621

(57) ABSTRACT

An in-line automated system for generating business forms. A spool of paper is unwound and fed into a tinter. A water-based tint is applied to the continuous stream of paper and then fed into a digital printer. The digital printer prints continuous streams of business forms onto the continuous stream of paper. The printer may print seven individual streams of product across the width of the paper. Shipping documentation may be printed concurrently with the printing of the product. After printing, the paper is fed into a binder delivery unit to cut and group the individual business forms into batches for shipment. The continuous sheet of paper may travel through the process at speeds of at least 100 feet per minute. The print job orders may be received via an online interface.

### BACKGROUND

Different systems exist for generating tinted business documents using digital printing techniques. Typically, these systems require human handling of the materials multiple times throughout the non-automated process. For example, a spool of paper may be unwound and fed through a water-based tinting apparatus. After the paper has been tinted, the paper may be rewound onto another spool or fed into a cutter and sliced individual sheets. Conventionally, the production process allows for the paper to dry after the tint has been applied. In some processes, additional equipment is used, such as UV dryers, to speed the drying process. Once the paper is dried, it is then fed into a digital printer by a human. In some cases, more than a day lapses between the tinting application and the digital printing process. The digital printer then prints characters and markings onto the sheet of paper. During this process, the paper is traditionally heated to temperatures in excess of 350 degree Fahrenheit. Once the printer has printed the necessary characters and markings on the sheet of paper, the paper is traditionally transported from the printer to a bindery system. The bindery system compiles, finishes and groups the various business documents and prepares the documents for shipping.

### SUMMARY

In one general aspect, the present invention is directed to an automated, in-line system for generating digitally-printed and tinted business forms. According to various embodiments, the system may comprise an unwinder that unwinds a continuous sheet of paper from a spool of paper. The system may also have a tinter that receives the continuous sheet of paper from the unwinder and applies a water-based tint to the continuous sheet of paper. The system may also comprise a digital printer that receives the continuous sheet of paper from the tinter and digitally prints markings on the continuous sheet of paper to create business forms. In one example embodiment, Magnetic Ink Character Recognition (MICR) technology is used when printing the markings. The system may further comprise a bindery delivery unit that receives the continuous sheet of paper from the digital printer and cuts the continuous sheets of paper into individual business forms. According to various embodiments, the continuous sheet of paper is routed through the tinter and the digital printer at a speed of at least 100 feet per minute. In some embodiments, the continuous sheet of paper is routed through the tinter and the digital printer at speeds greater than 200 feet per minute, such as 292 feet per minute, for example. In addition, the unwinder, the tinter, the printer, and the bindery unit may be in data communication. In addition, the paper may be printed within 5 seconds after being tinted with a water-based tint. In one embodiment, the paper is printed within 3 seconds after being tinted with a water-based tint.

In another general aspect, the present invention is directed to a method of receiving orders for and generating digitally-printed business forms. In example method, an order for business forms is received through a web-based interface and a job order may then be created for the order. Using an automated printing system, a spool of paper is then unwound to create a continuous sheet of paper. This continuous sheet of paper may be automatically feed into the tinter. The tinter may apply a water-based tint to the continuous sheet of paper. After receiving a tint, the continuous sheet of paper may be automatically feed into the digital printer. The digital printer digitally prints the job order onto the continuous sheet of paper. Shipping documentation and other additional documents may also be printed contemporaneously with the job order. The continuous sheet of paper may then be automatically fed into a binder delivery unit where the order is prepared for shipment. According to various embodiments, the continuous sheet of paper travels from the unwinder to the tinter at a speed of at least 100 feet per minute, from the tinter to the printer at a speed of at least 100 feet per minute, and from the printer to the binder delivery at a speed of at least 100 feet per minute. In various embodiments, the continuous sheet of paper may be received by the printer less than 5 seconds after the tint is applied to the continuous sheet of paper.

These and other benefits of the present invention will be apparent from the description that follows.

### FIGURES

Various embodiments of the present invention are described herein by way of example in conjunction with the following figures, wherein:

FIG. 1 shows a system diagram according to various embodiments of the present invention;

FIG. 2 shows a flow chart according to various embodiments of the present invention;

FIG. 3 shows a block diagram according to various embodiments of the present invention;

FIGS. 4A, 4B and 5 shows various business forms according to various embodiments of the present invention; and

FIG. 6 shows an example printed sheet of paper according to various embodiments of the present invention.

### DESCRIPTION

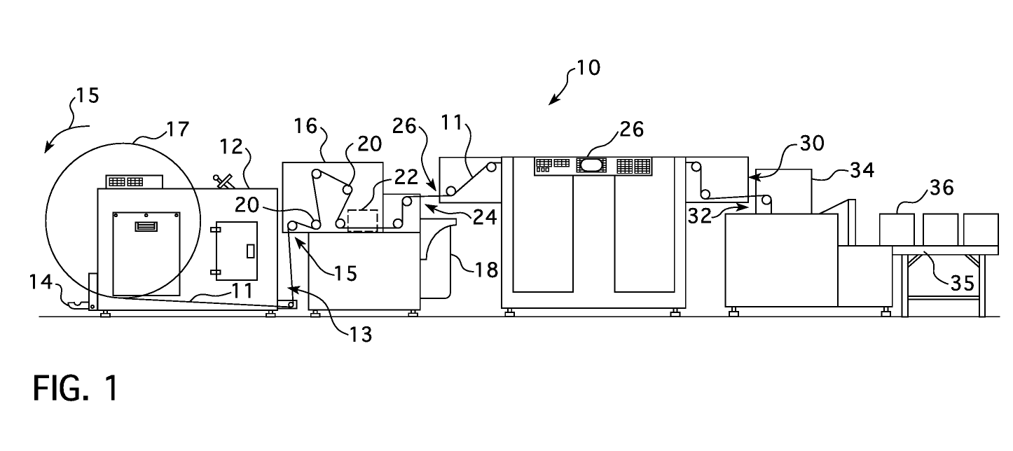

With reference to FIG. 1, an automated system 10 is shown in accordance with various embodiments of the present invention used for generating digitally printed business documents. The type of business documents created with the system 10 may be, without limitation, cash tickets, deposit slips, negotiable instruments, or any other type of form or document. As illustrated, a spool of paper 17 is mounted onto an unwinder 12. In one embodiment, the underwinder 12 is manufactured by EMT International, Inc. of Green Bay, Wis. The unwinder 12 may have a loading arm 14 to assist in the mounting of the spool of paper 17 onto the unwinder 12. The spool of paper 17 may rotate in the direction indicated by arrow 15 during the unwinding process. Upon unwinding the spool of paper 17, a continuous sheet of paper 11 is outputted from the unwinder 12. In one embodiment, the spool of paper 17 is unwound at a speed that produces a sheet of paper 11 traveling at least at 100 feet per minute. In some implementations, the sheet of paper 11 may travel at speeds of at least 200 feet per minute. In one embodiment, the sheet of paper 11 travels at speeds of at least 292 feet per minute. Positioned near an output 13 of the unwinder 10 is a tinter 16. In one embodiment, the tinter 16 is manufactured by GP Tinter AS of Skjetten, Norway. As illustrated, the sheet of paper 11 may feed directly into an input 15 of the tinter 16. It is appreciated that in various implementations, the unwinder 10 and the tinter 16 may be separate components (as illustrated) or combined as a single component.

The tinter 16 may store a liquid tint in a container 18. In various embodiments, the tint may be water-based. As appreciated by those skilled in the art, the tinter 16 may comprise a plurality of rollers 20 that route the sheet of paper 11 through the various stages of the tinter 16. The tinter 16 may apply the tint to the sheet of paper 11 using any suitable means, such as using a roller in a tinting applicator 22. The tinter 16 may apply the tint to the sheet of paper 11 in any desired formation or configuration, for example, the entire sheet of paper 11 may be tinted or just portions of the sheet of paper 11 may be tinted. Furthermore, as a variety of business documents may be generated sequentially or simultaneously from a single sheet of paper 11, it is appreciated that tint configuration may vary throughout the production process for a single spool of paper 17.

Positioned near an output 24 of the tinter 16, is an input 26 of a digital printer 28. In one embodiment, the digital printer 28 is manufactured by Océ N.V of Venlo, Netherlands. As illustrated, the digital printer 28 may receive the sheet of paper 11 directly from the output 24 of the tinter 16. Accordingly, the sheet of paper 11 may be traveling at substantially the same speed as it was during unwinding. In one embodiment, a tensioning device (not shown) may be located inline with the output 24 of the tinter 16 and the input 26 of the digital printer 28. The continuous sheet of paper 11 may travel through the tensioning device with the tensioning device absorbing or balancing the difference in tensions created by the tinter 16 and the digital printer 28. As may be appreciated, any difference in tension may be greater during initial startup and then decrease relatively quickly as the two machines reach similar run speeds. It is also appreciated that in various implementations, the tinter 16 and the digital printer 28 may be separate components (as illustrated) or combined as a single component.

As appreciated by those skilled in the art, the digital printer 28 may print the markings and characters onto the sheet of paper 11 using conventional digital printing techniques. In some implementations, various markings or indicia may be printed using magnetic ink in order to conform to various standards and regulations. For example, the business forms may be printed with Magnetic Ink Character Recognition (MICR) characters suitable for use with MICR technologies.

After printing, the sheet of paper 11 exits the printer via an output 30. The sheet of paper 11 then enters an input 32 of a bindery delivery unit 34. In one embodiment, a tensioning device (not shown) may be located inline with the output 30 of the digital printer 28 and the input 32 of bindery delivery unit 34. The continuous sheet of paper 11 may travel through the tensioning device with the tensioning device absorbing or balancing the difference in tensions created by the digital printer 28 and the bindery delivery unit 34. As may be appreciated, any difference in tension may be greater during initial startup and then decrease relatively quickly as the two machines reach similar run speeds.

In one embodiment, the bindery delivery unit 34 is manufactured by EMT International, Inc. The bindery delivery unit 34 cuts the sheet of paper 11 into the individual banking documents. The bindery delivery unit 34 may also group or stack the various printed materials to prepare them for shipment. The bindery delivery unit 34 may output the product to a continuous flow delivery table 35. The individual groups or stacks of documents may be placed in a box 36 for shipment. In various embodiments, a shipping label, a product packing list, a production ticket, a sample product for process control, a shipping header sheet, and other shipping documentation may be printed onto the sheet of paper 11 during the printing process. Accordingly, the necessary shipping paperwork may be printed in line with the various banking documents.

As may appreciated by those skilled in the art, due to the high speed of the sheet of paper 11 and the close proximity of the various components of the system 10, the entire process may transpire extremely fast. For example, the entire process for generating a particular form may take less 15 seconds from the time the sheet of paper 11 leaves the spool of paper 17 to the time it enters the bindery delivery unit 34. The system 10 may be a completely in-line, automated system that does not require an operator to interface between the various processes.

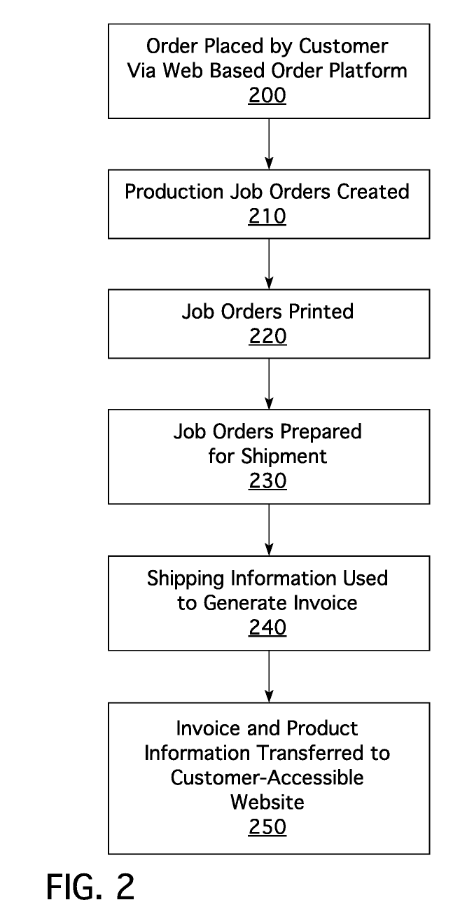

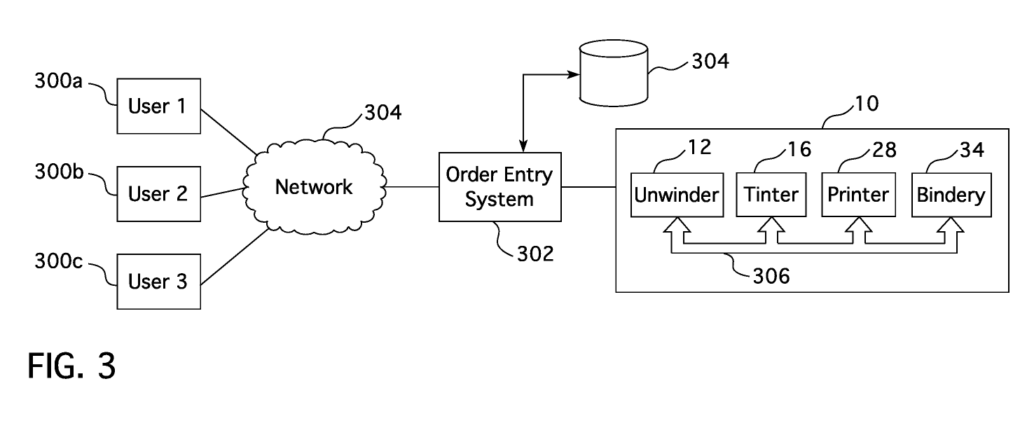

The system 10 may receive the various job orders through any suitable means, such as via telephone, intranet, electronic mail, facsimile, for example. As illustrated in FIG. 2, a customer may place an order via a web interface at 200. For example, the customer may specify the type of form, the order quantity, the design of the form, the shipping address, shipping method, the financial institution, and/or provide any other information necessary via a web interface. Once the order, or group of orders, has been received by an order entry system 302 (FIG. 3), production job orders may be created at 210. It is appreciated that similar job orders may be grouped together to provide for more efficient printing. The job orders may then be printed at 220. Once printed, the job orders may be prepared for shipment at 230. Using information received from the customer at the web interface, an invoice may be generated at 240. The invoice and other shipping information (such as status updates) may be transferred to the customer via the web interface at 250.

As illustrated in FIG. 3, various users 300 may connect to an order entry system 302 via a network. It is appreciated that the network may be any suitable network, such as a wireless network, local area network, or wireline network. Accordingly, the users 300 may interface with the order entry system 302 via an intranet connection or an internet connection. In some implementations, users 300 may use a computer, PDA, cell phone, or other device to connect to the order entry system 302. A database 304 may be coupled to the order entry system 302 to facilitate data storage and retrieval functionality. For example, a user profile for user 300a may be stored in the database 304. The order entry system 302 may compile the orders and create the job orders sent to the system 10 for processing. Accordingly, the order entry system 32 may be in data communication with the various components of the system 10. Furthermore, the various components of the system 10 may be in communication with each other via any suitable technique, such as a data bus 306. Communication between the various components of the system 10 allows for coordination during the production process. For example, as the unwinder 12 begins to unwind the spool 17, it can communicate with the tinter 16 to coordinate the speed of the tinting operation. The tinter 16 may also be in data communication with the printer, or any other component of the system 10. Also, in other embodiments, direct point-to-point communications channels may be used instead of a data bus.

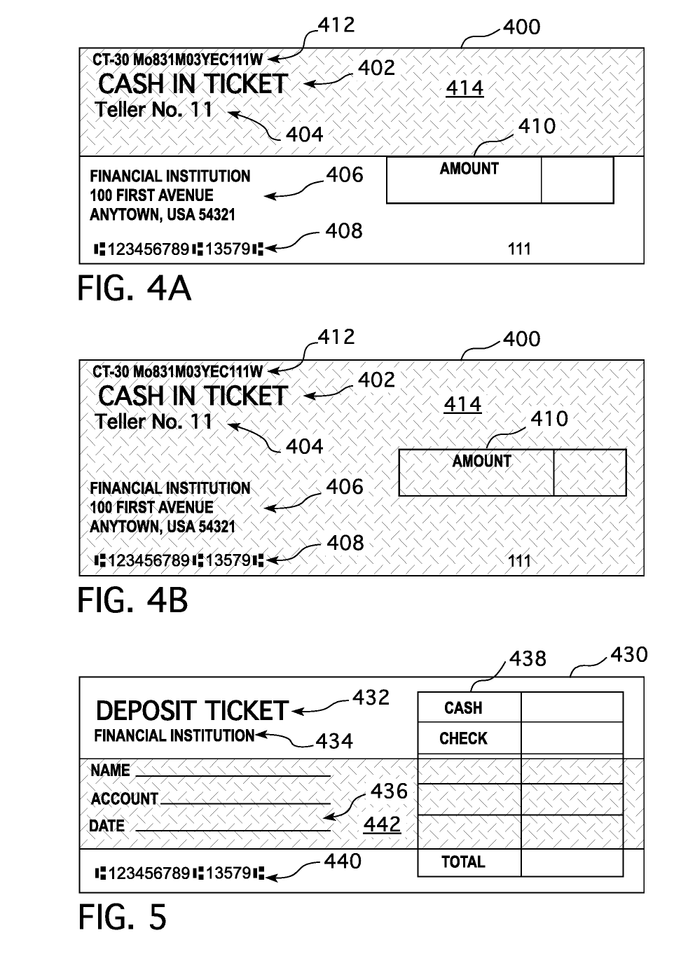

Various embodiments of business forms are illustrated in FIGS. 4-5. Referring first to FIG. 4A, a cash ticket 400 may include a title 402, a teller number 404, financial institutional information 406, tracking data 408, and an amount block 410. It is appreciated that other markings, such as indicia 412, may appear on various cash tickets. Furthermore, the markings and characters on the cash ticket 400 may appear in a variety of locations. As illustrated, a section 414 is shown tinted. The area of the cash ticket that is tinted may vary for various job orders. For example, FIG. 4B illustrates an example cash ticket 400′ that is completely tinted. It is appreciated that other configurations of tinting may be used. FIG. 5 illustrates another type of form that may be generated via the system 10. A deposit ticket 430 is shown that comprises a title 432, financial institutional information 434, customer information spaces 436, a deposit grid 438, and tracking data 440. In the illustrated embodiment, a section 442 is shown tinted, although the deposit ticket 430 could be tinted in any desirable configuration. Furthermore, other types of documents, forms, and negotiable instruments may be generated using the system 10. It is appreciated that variety of forms may be printed onto the sheet of paper 11 from a single spool of paper 17. For example, a job order of one thousand cash tickets may be followed by an order of five thousand deposit tickets, and another order of another variety of cash ticket may follow the deposit tickets. As discussed above, the required shipping documentation, such as shipping labels, may be printed immediately after each individual job order is printed.

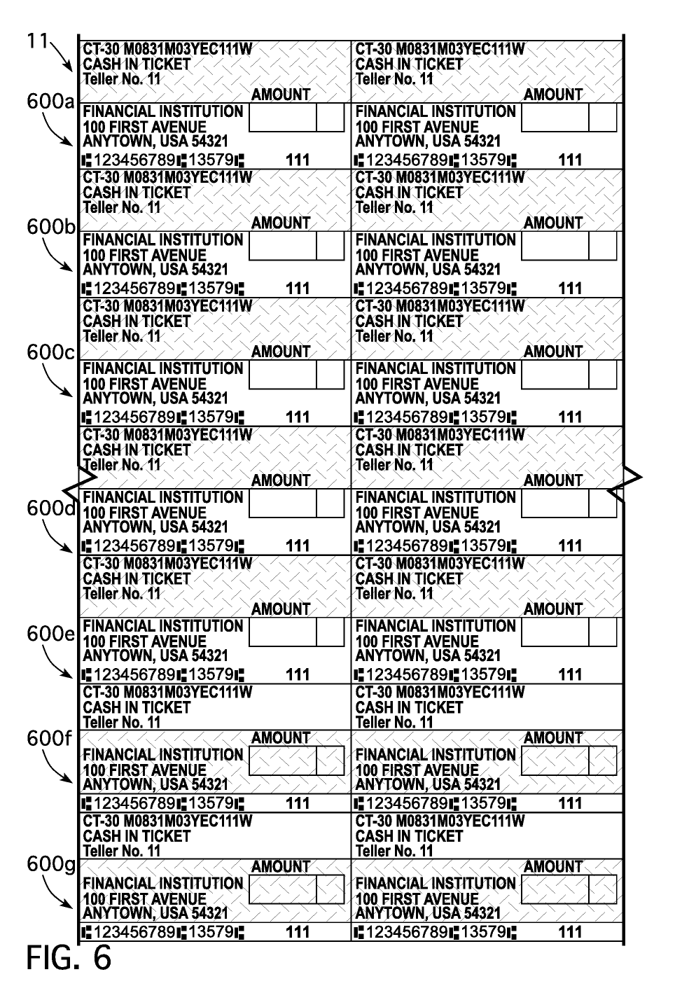

FIG. 6 illustrates a section of the sheet of paper 11 subsequent to printing. The sheet of paper 11 may have a width 602. As the sheet of paper 11 travels through the printer 28 (FIG. 1), multiple streams 600 of products may be printed across the width 602. As illustrated, seven streams of products may be printed side by side on the sheet of paper 11. In one embodiment, the sheet of paper 11 is 19¼ inches wide and the individual products have a width of 2¾ inches and a length of 7 inches. It is appreciated that documents of varying with widths and lengths may be printed onto the sheet of paper 11.

As illustrated, the streams 600 may have varying tinting configurations. For example, streams 600a-600e may have a first tinting configuration, while streams 600f-600g may have a second tinting configuration. In some embodiments, each stream 600 may have a unique tinting configuration. Furthermore, the markings and indicia printed on the streams 600 may vary per stream, or may vary per each business form in each stream. It is appreciated that the markings and indicia printed on the products in each stream may be determined by the user 300 (FIG. 3) via interaction with the order entry system 302 (FIG. 3).

As used herein, a “computer” or “computer system” may be, for example and without limitation, either alone or in combination, a personal computer (“PC”), server-based computer, main frame, server, grid computer, microcomputer, minicomputer, laptop, personal data assistant (“PDA”), cellular phone, processor, including wireless and/or wireless varieties thereof, and/or any other computerized device capable of configuration for receiving, storing, and/or processing data for standalone applications and/or over the networked medium or media.

In general, computer-readable memory media applied in association with embodiments of the invention described herein may include any memory medium capable of storing instructions executed by a programmable apparatus. Where applicable, method steps described herein may be embodied or executed as instructions stored on a computer-readable memory medium or memory media. These instructions may be software embodied in various programming languages such as C++, C, Java, and/or a variety of other kinds of computer programming languages that may be applied to create instructions in accordance with embodiments of the invention. As used herein, the terms “module” and “engine” represent software to be executed by a processor of the computer system. The software may be stored in a memory medium.

The database 304, the order entry system 302, or any associated components or modules, may include operatively associated computer-readable media such as memory for storing software applications used in obtaining, processing, storing, and/or communicating data. It can be appreciated that such memory can be internal, external, remote, or local with respect to its operatively associated computer or computer system. Memory may also include any means for storing software or other instructions including, for example and without limitation, a hard disk, solid state disk, optical disk, floppy disk, DVD, compact disc, memory stick, ROM (read only memory), RAM (random access memory), PROM (programmable ROM), EEPROM (electrically erasable PROM), and/or other like computer-readable media.

The examples presented herein are intended to illustrate potential and specific implementations of the embodiments. It can be appreciated that the examples are intended primarily for purposes of illustration for those skilled in the art. No particular aspect or aspects of the examples is/are intended to limit the scope of the described embodiments.

The processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, magnetic disk, or solid state disk. Furthermore, at least some of the processes may be programmed when the computer system is manufactured or stored on various types of computer-readable media.

While several embodiments of the invention have been described, it should be apparent, however, that various modifications, alterations and adaptations to those embodiments may occur to persons skilled in the art with the attainment of some or all of the advantages of the present invention. It is therefore intended to cover all such modifications, alterations, and adaptations without departing from the scope and spirit of the present invention as defined by the appended claims.

What is claimed is:

1. A system for generating business forms, comprising:
an unwinder that unwinds a continuous sheet of paper from a spool of paper;
a tinter that receives the continuous sheet of paper from the unwinder and applies a water-based tint to the continuous sheet of paper;
a digital printer that receives the continuous sheet of paper from the tinter and digitally prints markings on the continuous sheet of paper to create business forms;
a bindery delivery unit that receives the continuous sheet of paper from the digital printer and cuts the continuous sheets of paper into individual business forms;
wherein the continuous sheet of paper is routed through the tinter and the digital printer at a speed of at least 200 feet per minute.

2. The system of claim 2, wherein the continuous sheet of paper is routed through the tinter and the digital printer at a speed of at least 250 feet per minute.

3. The system of claim 3, wherein the continuous sheet of paper is routed through the tinter and the digital printer at a speed of at least 292 feet per minute.

4. The system of claim 1, wherein the continuous sheet of paper has a width and a plurality of streams of business forms are printed across the width.

5. The system of claim 4, wherein seven streams of business forms are printed across the width.

6. The system of claim 5, wherein the business forms are a cash tickets.

7. The system of claim 6, wherein the tinter applies a tint to a portion of the cash ticket.

8. The system of claim 7, wherein the printer prints markings on the tinted portion of the cash ticket.

9. The system of claim 1, wherein the markings are MICR characters.

10. The system of claim 1, wherein the tinter and the digital printer are in data communication.

11. A system for generating business forms, comprising:
an unwinder that unwinds a continuous sheet of paper from a spool of paper;
a tinter that receives the continuous sheet of paper from the unwinder and applies a water-based tint to the continuous sheet of paper;
a digital printer that receives the continuous sheet of paper from the tinter and digitally prints markings on the continuous sheet of paper to create business forms;
a bindery delivery unit that receives the continuous sheet of paper from the digital printer and cuts the continuous sheets of paper into individual business forms; and
wherein the unwinder and the tinter are in data communication.

12. The system of claim 11, wherein the continuous sheet of paper has a width and a plurality of streams of business forms are printed across the width.

13. The system of claim 12, wherein seven streams of business forms are printed across the width.

14. The system of claim 13, wherein the business forms are a cash tickets.

15. The system of claim 11, wherein the tinter applies a tint to a portion of the business form.

16. The system of claim 15, wherein the printer prints markings on the tinted portion of the cash ticket.

17. The system of claim 11, wherein the markings are MICR characters.

18. A system for generating business forms, comprising:
an unwinder that unwinds a continuous sheet of paper from a spool of paper;
a tinter that receives the continuous sheet of paper from the unwinder and applies a water-based tint to the continuous sheet of paper;
a digital printer that receives the continuous sheet of paper from the tinter and digitally prints markings on the continuous sheet of paper to create business forms;
a bindery delivery unit that receives the continuous sheet of paper from the digital printer and cuts the continuous sheets of paper into individual bank forms;
wherein the continuous sheet of paper is received by the printer less than 5 seconds after the water-based tint is applied to the continuous stream of paper.

19. The system of claim 18, wherein the continuous sheet of paper is received by the printer less than 3 seconds after the water-based tint is applied to the continuous stream of paper.

20. The system of claim 19, wherein the continuous sheet of paper has a width and a plurality of streams of business forms are printed across the width.

21. The system of claim 20, wherein seven streams of business forms are printed across the width.

22. The system of claim 21, wherein the business form is a cash ticket.

23. The system of claim 22, wherein the tinter applies a tint to a portion of the cash ticket.

24. The system of claim 18, wherein the tinter and the digital printer are in data communication.

25. A method for generating business forms, comprising:
receiving a job order for business forms through a web-based interface;
unwinding a continuous sheet of paper from a spool of paper with an unwinder;
automatically feeding the continuous sheet of paper into a tinter;
applying a water-based tint to the continuous sheet of paper;
automatically feeding the continuous sheet of paper into a digital printer;
digitally printing the job order onto the continuous sheet of paper;
digitally printing shipping documentation onto the continuous sheet of paper;
automatically feeding the continuous sheet of paper into a binder delivery unit;
preparing the job order for shipment; and wherein the continuous sheet of paper travels from the unwinder to the tinter at a speed of at least 200 feet per minute; wherein the continuous sheet of paper travels from the tinter to the printer at a speed of at least 200 feet per minute; wherein the continuous sheet of paper travels from the printer to the binder delivery at a speed of at least 200 feet per minute.

26. The method of claim 25, wherein multiple streams of business forms are printed across a width of the continuous sheet of paper.

27. The method of claim 26, wherein seven streams of business forms are printed across the width of the continuous sheet of paper.

28. The method of claim 27, wherein the business forms are cash tickets.

29. The method of claim 28, wherein the unwinder, tinter, and printer are configured in an inline format.

30. The method of claim 25, wherein MICR characters are printed on the continuous sheet of paper.

31. A method for generating business forms, comprising:
receiving a job order for business forms through a web-based interface;
unwinding a continuous sheet of paper from a spool of paper with an unwinder;
automatically feeding the continuous sheet of paper into a tinter;
applying a water-based tint to the continuous sheet of paper;
automatically feeding the continuous sheet of paper into a digital printer;
digitally printing the job order onto the continuous sheet of paper;
digitally printing shipping documentation onto the continuous sheet of paper;
automatically feeding the continuous sheet of paper into a binder delivery unit;
preparing the job order for shipment; and wherein the continuous sheet of paper is received by the printer less than 3 seconds after the water-based tint is applied to the continuous stream of paper.

32. The method of claim 31, wherein MICR characters are printed on the continuous sheet of paper.

33. The method of claim 31, wherein the unwinder, tinter, and printer are configured in an inline format.

34. The method of claim 31, wherein the business forms are cash tickets.
